(19) United States
(12) Patent Application Publication
(10) Pub. No.: US 2008/0056816 A1
(43) Pub. Date: Mar. 6, 2008

(54) QUICK CONNECT CLOSURE FOR CONNECTING TWO STRUCTURAL MEMBERS

(76) Inventor: Rainer Sussenbach, Steinhagen (DE)

Correspondence Address: SEYFARTH SHAW LLP, 131 S. DEARBORN ST., SUITE2400, CHICAGO, IL, 60603-5803, US

(21) Appl. No.: 11/847,987

(22) Filed: Aug. 30, 2007

(30) Foreign Application Priority Data
Sep. 6, 2006 (DE) 20 2006 013 666.5

(51) Int. Cl. F16B 21/02

(52) U.S. Cl. 403/348; 403/325

(57) ABSTRACT

A quick connect closure for connecting first and second structural members, said quick connect closure comprising a female part adapted to be connected to said first structural member and comprising a pair of opposite spring legs, and a closure pin adapted to be mounted to said second structural member so as to be rotatable about an axis of said quick connect closure and comprising a drive portion, a shaft-like intermediate portion and a closure body, said closure pin being adapted to be axially inserted into said female part in order to provide for a locking connection between said closure pin and said female part when said female part and said closure pin are in at least one locking position with respect to each other, and said spring legs of said female part cooperating with said closure body of said closure pin such that the closure pin is automatically rotated into said at least one locking position when the closure pin is in a rotational position spaced from said at least one locking position at the time when the closure pin is inserted into said female part, the improvement being that said female part is made of plastic material and is formed as a circumferentially closed box-type body having a pair of wall portions comprising said spring legs which are radially inwardly offset with respect to the remaining box-type body and are resiliently connected thereto.

### FIELD OF THE INVENTION

The present invention relates to a quick connect closure for connecting two structural members in accordance with the preamble of claim 1.

### BACKGROUND OF THE INVENTION

These types of quick connect closures are known from DE 91 01 514 U1 and DE 94 06 129 U1 of the applicant. These previously known quick connect closures have a female part consisting of a spring clamp made of spring steel and a ring-shaped fastening portion, on which two axially running spring legs are formed. The closure pin is preferably made of plastic and consists of a handle piece and a “toggle-shaped” end piece and a necking designed as a locking contour between the end piece and the handle piece. The end piece and the locking contour have a relatively complicated geometrical shape with diametrically running inclined surfaces provided on the end piece. These inclined surfaces are intended to rotate the closure pin into the locking position when the locking pin assumes a rotational position that is different from the locking position when inserted into the spring clamp. Although this quick connect closure has proven itself in practice, it still has certain disadvantages, which stem in particular from the use of a spring clamp made of spring steel. The production of the spring clamp is comparatively expensive in particular due to the annealing of the spring steel. Furthermore, the spring clamp is subject to fatigue in the case frequent operation, to loss of elasticity when overexpanded, to breaks under impact loads and to corrosion problems. The closure pin is difficult to produce due to its complicated geometric shape and sometimes leaves something to be desired with respect to operational reliability (reliability of the automatic rotation into the locking position during the insertion process).

### SUMMARY OF THE INVENTION

These disadvantages are to be avoided with the present invention. In particular, the object of the present invention is to further develop a quick connect closure for connecting two structural members of the type specified in claim 1 such that the risk of fatigue, overexpansion and breakage of the spring legs of the female part is avoided with the lowest possible production costs and a high operational reliability of the quick connect closure.

This object is solved by the quick connect closure defined in claim 1.

In the quick connect closure designed according to the invention, the female part is made of plastic and is designed as a circumferentially closed box-type body, which has two wall portions serving as spring legs, which are offset radially inwards with respect to the remaining box-type body and are resiliently connected thereto.

The design of the female part as a box-type body allows the female part to be made of plastic. The disadvantages resulting from the use of a spring clamp made of spring steel in the state of the art are thus avoided.

In another embodiment of the invention, it is provided that the spring legs of the female part are connected with the remaining box-type body through a pair of wave-shaped portions, which together with the spring legs in radial planes perpendicular to the axis have a trapezoidal shape.

The female part can preferably be connected with the first structural member by a snap-lock connection, which is formed by flange portions and projections of the box-type body.

As will be explained in greater detail, the closure pin is characterized by a simplified, geometric shape, which ensures a high operational reliability for the location of the locking position during the insertion process.

The female part made of plastic can be produced through injection molding, which considerably simplifies production and almost cuts in half the production costs of the quick connect closure with respect to the initially discussed quick connect closures of the state of the art. The use of plastic instead of spring steel for the female part leads to numerous other advantages, such as the avoidance of corrosion, simplified recycling and electromagnetic compatibility of the materials of the quick connect closure, avoidance of the risk of breakage, overexpansion and reduction of the holding force of the female part, high operational reliability and the long service life of the quick connect closure.

### BRIEF DESCRIPTION OF THE DRAWINGS

An exemplary embodiment of the invention is explained in greater detail based on the drawings.

FIG. 1 shows a longitudinal section through a quick connect closure designed according to the invention in an installed state (locked position);

FIG. 2 shows a section in the line of site of arrows II-II in FIG. 1;

FIG. 3 shows a section in the line of site of arrows III-III in FIG. 1;

FIG. 4 shows a partial sectional representation of the quick connect closure shown in FIG. 1 before the insertion process;

FIG. 5 shows a partial sectional representation of the quick connect closure during an insertion process, in which the closure pin is located in a rotational position that is different from the locking position;

FIG. 6 shows a section in the line of site of arrows VI-VI in FIG. 5;

FIG. 7 shows a lateral view of the female part of the quick connect closure;

FIG. 8 shows a lateral view of the female part in FIG. 7 rotated by 90°;

FIG. 9 shows a sectional representation in the line of site of arrows IX-IX in FIG. 8;

FIG. 10 shows a view of the female part from below;

FIG. 11 shows a perspective view of the female part from above;

FIG. 12 shows a perspective view of the female part from below;

FIG. 13 shows a lateral view of the closure body of the quick connect closure;

FIG. 14 shows a lateral view of the closure body in FIG. 13 rotated by 90°;

FIG. 15 shows a view of the closure body from below;

FIG. 16 shows a section in the line of site of arrows XVI-XVI in FIG. 13;

FIG. 17 shows a perspective view of the closure pin;

FIG. 18 shows a sectional representation of the quick connect closure during opening;

FIG. 19 shows a sectional representation in the line of site of arrows XIX-XIX in FIG. 18;

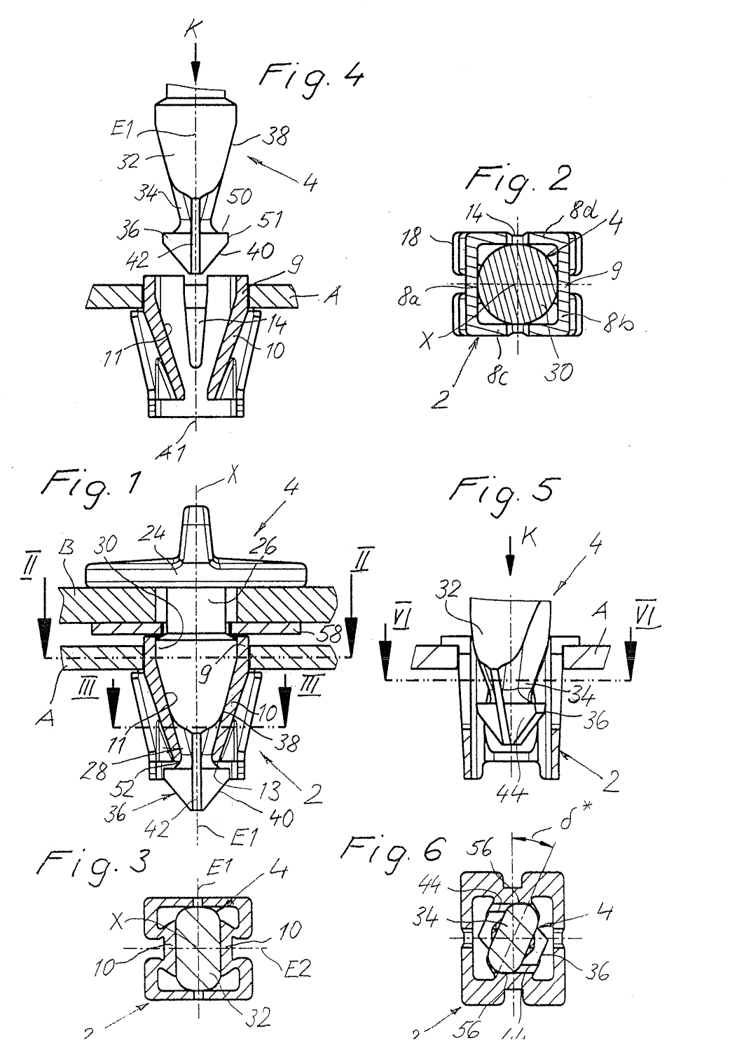

### DETAILED DESCRIPTION OF A PREFERRED EMBODIMENT OF THE INVENTION

The quick connect closure shown in FIG. 1 serves to connect two structural members A, B. It consists of a female part 2 and a closure pin 4, of which the female part 2 can be firmly connected with the structural member A and the closure pin 4 is held on structural member B in a pivotable and axially undetachable manner. Structural member A is for example a housing, and structural member B is for example a cover for closing the housing.

In FIG. 1, the quick connect closure is located in its closed state, in which the closure pin 4 assumes one of two locking positions, which are offset by 180° with respect to a central axis X of the quick connect closure. The closing of the quick connect closure only requires an axial relative movement between the structural members A and B (see arrow K in FIG. 4), in which the closure pin 4 is inserted into the female part 2. If the closure pin 4 is located in a rotational position that is different from the two locking positions, then it is automatically rotated—by a maximum of 90°—into one of the two locking positions through the interaction between the closure pin 4 and the female part 2, as will be explained in greater detail below.

### The Female Part

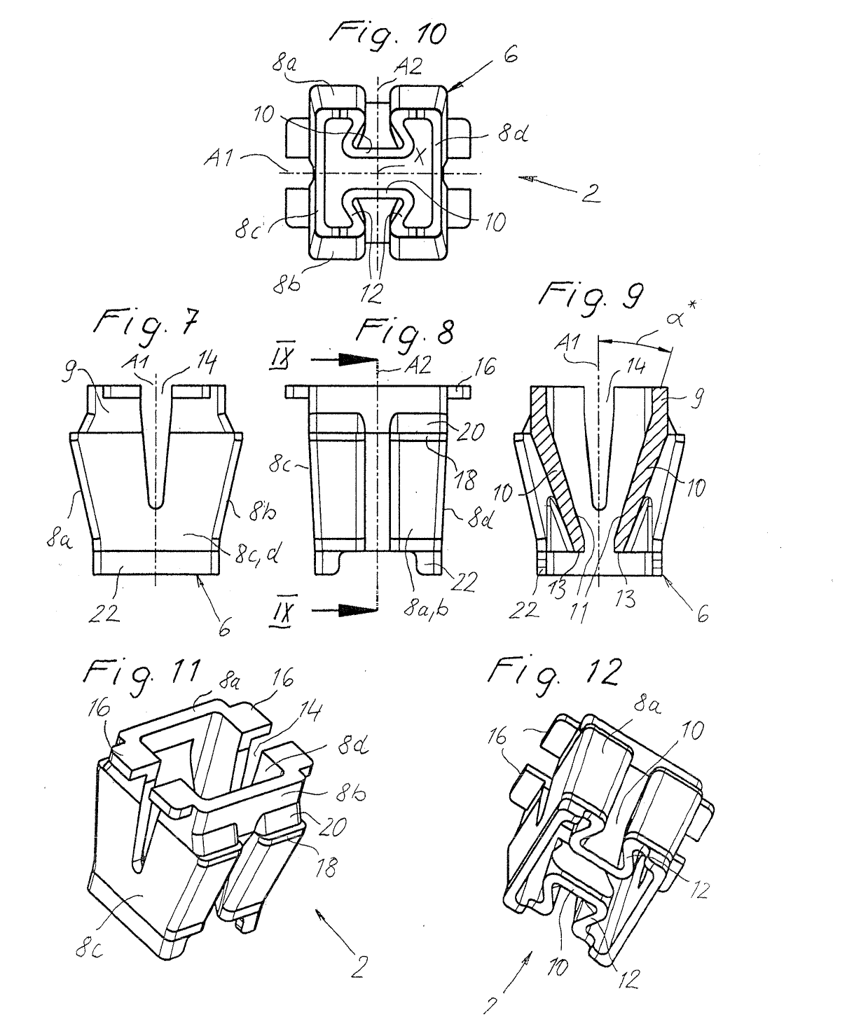

The female part 2 shown in FIGS. 7 through 12 is made of plastic, preferably a polyamide or an elastomer, in which the elastomer can be thermoplastic or cross-linked. The plastic has a high expansion of e.g. 50% (polyamide) or even up to 200% (elastomer), in order to give the female part 2 the elasticity for its function. The female part 2 is advantageously produced through injection molding.

As can be seen in FIGS. 7 through 12, the female part 2 consists of a box-type body 6 closed in the circumferential direction with four walls 8a, b, c, d. The opposite walls 8a, b are designed mirror-symmetrically with respect to an axial plane A1 running through the axis X and the two other walls 8c, d are designed mirror-symmetrically with respect to an axial plane A2, which is rotated 90° with respect to the axial plane A1. The four walls 8a, b, c, d are interconnected via rounded corner areas, in order to form the box-type body 6 that is closed in the circumferential direction and that is open on both of its axial ends.

The box-type body 6 has an upper end area 9, which has a square inner circumference and in which the walls 8a, b run parallel to the axial plane A1 and the walls 8c, d run parallel to the axial plane A2. The opposite walls 8a, 8b run diagonally inwards from the end area 9, wherein they form a specified angle with the axial plane A1. The walls 8c, 8d also run diagonally inwards, but form a substantially smaller angle with the axial plane A2.

In the area below the end area 9, the opposite walls 8a, 8b are provided with two inwardly offset wall portions, which are resiliently connected with the remaining wall portions of the walls 8a, 8b through wave-shaped portions 12 in order to form spring legs 10, see in particular FIGS. 9, 10, 12. Each spring leg 10 with the two wave-shaped portions 12 has in radial planes (drawing plane of FIG. 10) a trapezoidal progression, which tapers from radial inside to radial outside. Through the trapezoidal progression and the properties of the plastic used, the spring legs 10 have a high flexibility with sufficient restoring force which is required for the function of the quick connect closure, as will be explained in greater detail.

The wall thickness of the spring legs 10 decreases from the (in FIG. 9) bottom end to the upper end in a wedge-shaped manner. The dimensions of the spring legs 10 and the wave-shaped portions 12 lying in radial planes are also smaller from the bottom end to the top end so that the trapezoidal progression of the spring legs 10 and wave-shaped portions 12 tapers from bottom to top (see FIG. 12). This results in an even tension distribution over the axial length in the locking position of the quick connect closure.

Due to the slope of the walls 8a, 8b, the spring legs 10 are also correspondingly sloped so that the inner surfaces 11 of the spring legs 10 each comprise an angle of inclination α* with the axial plane A1. The spring legs 10, which are designed to be level on both their inner surfaces 11 as well as their outer surfaces, are bordered by sharp-edged faces 13 on the axial ends turned away from the end area 9.

The female part 2 is connected with the structural member A through a snap-lock connection. For this purpose, each of the box-type bodies 6 on the walls 8c, d is provided with a longitudinally running slot 14, which is open on its (in FIGS. 7 and 9) upper end. The slots 14 give the box-type body 6 the flexibility required for the snapping in of the snap-lock connection.

The snap-lock connection is formed by flange portions 16, projections 18 and inclined surfaces 20 of the box-type body 6. In the exemplary embodiment shown, four flange portions 16 are provided, which are shaped on the walls 8c, d and of which two are arranged on both sides of one slot 14, see FIG. 11. Furthermore, four projections 18 and four inclined surfaces 20 are provided, which are arranged on the other two walls 8a, b on the bottom end of the end area 9 of the female part 2.

The walls 8c, 8d designed free of spring legs are elongated by extensions 22 downwards over the bottom ends of the spring legs 10, as can be seen in particular in FIGS. 8, 9 and 11.

### The Closure Pin

As can be seen in FIG. 1, the closure pin 4 comprises a drive portion 24, a shaft-like intermediate portion 26 and a closure body 28.

The drive portion 24 is designed as a handle in the exemplary embodiment shown in order to be able to open the quick connect closure manually. However, it can be provided with multiple sides, a slot or suchlike for actuation by means of a tool.

The shaft-like intermediate portion 26 is designed cylindrically and connects the drive portion 24 with the closure body 28.

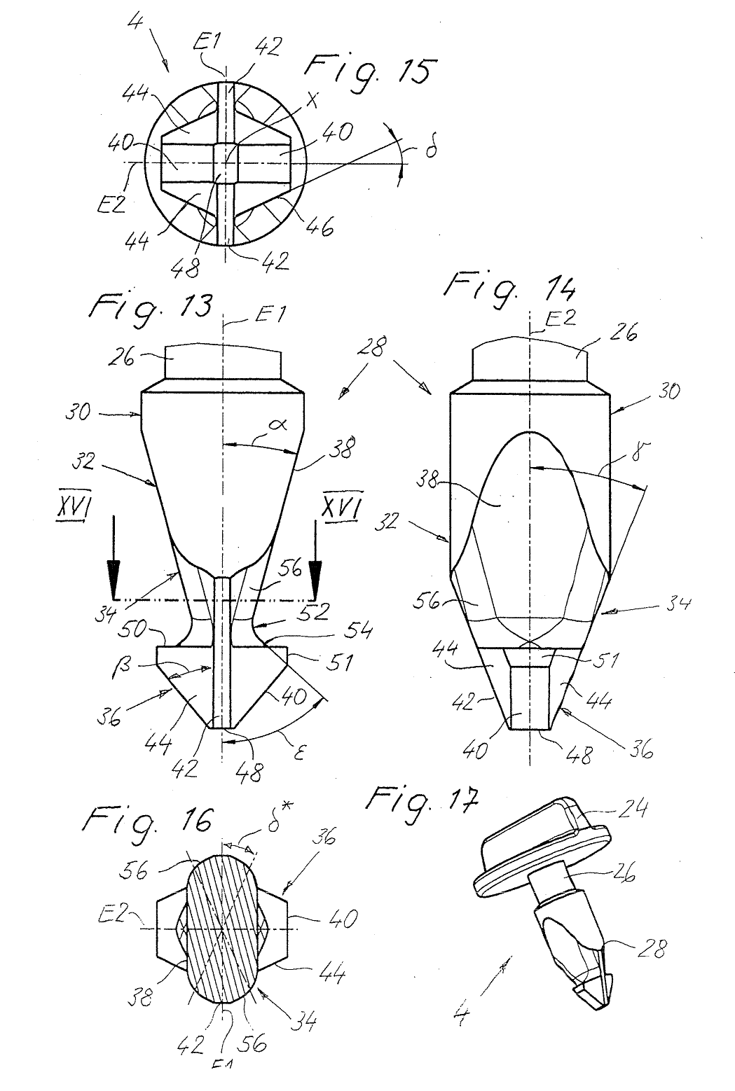

Please also see FIGS. 13 through 17 for the description of the closure body 28. As shown in particular in FIGS. 13, 14 and 17, the closure body 28 is comprised of a cylindrical shaft portion 30, a contact portion 32 tapering downwards, a contoured portion 34 tapering even further and an expanded head portion 36. The portions 30, 32, 34 and 36 pass seamlessly into each other and partially have surfaces, which extend over more than two portions.

The contact portion 32 connected to the cylindrical shaft portion 30 has two planar contact surfaces 38, which are arranged mirror-symmetrically with respect to an axial plane E1, form an angle of inclination α with it and is arranged in the middle with respect to an axial plane E2 offset by 90°. Outside of the contact surfaces 38, the contact portion 32 is made of an axial elongation of the cylindrical shaft portion 30, as can be seen in particular in FIG. 14. Thus, the contact portion 32 has a cross-section, which changes from a circular cross-section on the upper end into an increasingly flatter oval portion in the bottom area.

The head portion 36 has, as can be seen in particular in FIGS. 13 through 15, two planar rectangular guide surfaces 40, two planar rectangular push surfaces 42 and four planar inclined surfaces 44. The guide surfaces 40 are arranged mirror-symmetrically to the axial plane E1, are tilted at an angle of inclination β (FIG. 13) with respect to it and are arranged in the middle with respect to the axial plane E2. The push surfaces 42 are arranged mirror-symmetrically to the axial plane E2, are tilted at an angle of inclination γ (FIG. 14) with respect to it and are arranged in the middle with respect to the axial plane E1.

The angle of inclination β is for example on the order of 40°. The angle of inclination γ is preferably larger than 22°, as will be explained in greater detail.

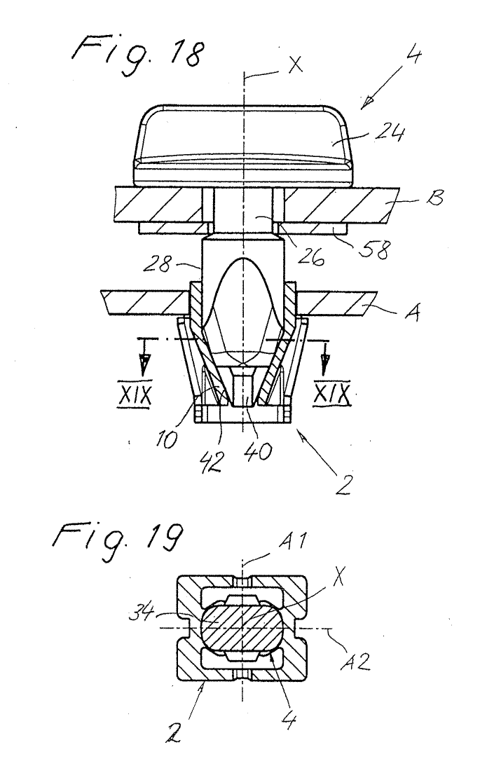

Each of the four inclined surfaces 44 runs between a guide surface 40 and a push surface 42 such that it is tilted both with respect to the axial plane E1 as well as the axial plane E2. As can be seen in FIG. 15, the lateral edges 46 of the inclined surfaces 44 lying in a radial plane form an angle δ with the axial plane E2.

The slope of the surfaces 40, 42 and 44 is selected such that the head portion 36 forms a search peak, the cross-section of which tapers from the top to the bottom (in FIGS. 13, 14). The rectangular guide surfaces 40 and the rectangular push surfaces 42 end in the planar, rectangular face 48 of the head portion 36 (FIGS. 13 through 15). On the back side of the head portion 36, a shoulder 50 lying in a radial plane is provided (FIG. 13), which forms an undercut together with the contoured portion 34. The guide surfaces 40 are connected with the shoulder 50 via outer surfaces 51, which run parallel to the axial plane E1.

The contoured portion 34 connects the contact portion 38 with the head portion 36. On the two opposite sides, the contoured portion 34 is bordered by the push surfaces 42, which are elongated from the head portion 36 into the contoured portion 34 up to the contact portion 32. On the sides offset by 90°, the contoured section 34 is bordered by contact surfaces 38, which are elongated into the contoured portion 34 from the contact portion 32. Each of the contact surfaces 38 are connected via a radius 52 and a tangentially running short surface 54 with the back side (shoulder 50) of the head portion 36, wherein the surfaces 54 with the axial plane E1 form an angle ε (FIG. 13). The angle ε is for example on the order of 48°. All contact surfaces 38 and push surfaces 42 in the area of the contoured portion 34 are connected with each other by a rounded corner area 56 so that the contoured portion 34 in radial planes has an oval cross-section similar to a rectangle (FIG. 16), which becomes increasingly flat in the direction of the head portion 36.

The meaning of the described geometry of the closure body 28 and the closure pin 4 is explained in greater detail in connection with a description of the functionality of the quick connect closure.

The closure pin is also preferably made of plastic, e.g. a fiber-reinforced polyamide, but can also be made of other substances such as e.g. a metallic substance. Production methods are for example zinc, aluminium, die-casting and PIM (powder injection molding) methods and similar metallic production methods.

### Mounting of Female Part and Closure Part on Structural Members A, B

In order to fasten the female part 2 on the structural member A (FIGS. 1 and 4), the female part 2 is inserted from above into the square opening of structural member A. The diagonally running walls 8a, b of the box-type body 6 are warped inwards with respect to the axial plane A1, which is enabled by the two slots 14. The insertion process is complete when the flange portions 16 hit the structural member A and the projections 18 snap behind the back side of structural member A through the outwards springing of the walls 8a, b of the box-type body 6. The axial distance between the bottom side of the flange portions 16 and the top side of the projections 18 is somewhat larger than the thickness of the structural member A. However, the inclined surfaces 20 between the projections 18 and the walls 8a, b of the end area 15 ensure a play-free seating of the structural member A on the female part 2, since it comes to a type of press fit for the structural member A between the flange portions 16 and the inclined surfaces 20. The female part 2 is thus free of play in both the axial radial directions on structural member A.

In order to mount the closure pin 4 on the structural member B, the closure pin 4 with the closure body 28 forward is inserted through a passage opening of the structural member B and is held in place using a washer 58. The washer 58 is for example provided with radial slots (not shown), in order to be able to push the washer 58 over the closure body 28 into the intermediate portion 26 of the closure pin 4. Another option for securing the closure pin 4 is to press the closure body 28 in a force-fit member through the passage opening of structural member B.

In each case, the closure pin 4 is held securely on structural member B such that the central axis X of the quick connect closure can be rotated and is supported axially on the structural member B in the axial direction using the drive portion 24.

### Locking Position of the Quick Connect Closure

FIG. 1 shows the quick connect closure in the closed state, in which the female part 2 and the closure pin 4 are located in one of two locking position relative to each other. In the locking positions, the closure pin 4 assumes a rotational position relative to the female part 2 such that the two contact surfaces 38 of the closure pin 4 rest against the correspondingly sloped inner surfaces 11 of the spring legs 10. This is the case if the axial planes E1 and E2 of the closure pin 4 coincide with the axial planes A1 and A2 of the female part 2. Due to the mirror symmetry of the adjacent surfaces 11, 38 of the female part 2 and the closure pin 4, there are thus two locking positions offset by 180°.

In the locking positions, in which the quick connect closure connects the structural members A and B with each other, the female part 2 is fastened to the structural member A, and the closure pin 4 is connected in a rotatable manner with the structural components B, as was described above. The drive portion 24 of the closure pin 4 is hereby supported on the top side of the structural member B. The shaft-like intermediate portion 26 with the decreased diameter extends with play through the passage opening of structural member B. 1). The closure body 28 of the closure pin 4 is removed from the female part 2 as follows (FIG. 1):

The cylindrical shaft portion 30 of the closure body 28 sits inside the spring-leg-free square end area 9 of the female part 2. Since the diameter of the cylindrical shaft area 26 corresponds with the side length of the square inner circumference of the end area 9, a play-free seating is established in the radial direction. Since the square end area 9 of the female part 2 is also arranged inside the receiving opening of the structural member A, a radial evasion of the female part 2 is prevented in the slot 14 provided in the female part 2.

The contact surfaces 38 of the closure body 28 of the closure pin 4 rest against the inner surfaces 11 of the spring legs 10 over their entire length and width. Advantageously, the angle of inclination α* of the inner surfaces 11 of the spring legs 10 in an unwarped state is somewhat larger than the angle of inclination α of the contact surfaces 38 of the closure pin 4. For example, the angle of inclination α* is on the order of 17° and the angle of inclination α is on the order of 15°. A tight fit between the closure pin 4 and the female portion 2 is achieved in the area of surfaces 11 and 38 in this manner. As already mentioned, the wedge-shaped, changing wall thickness of the spring legs as well as the trapezoidal, axially tapering progression of the spring legs 10 and wave-shaped portions 12 ensure an even tension distribution over the axial length.

Furthermore, in the locking positions, the sharp-edged faces 13 of the spring legs 10 rest against the radii 52 or surfaces 54 of the contoured portion 34 of the closure pin 4. For one, this enables an equalization of production tolerances in the axial direction. The sharp-edged faces 13 of the spring legs 10 also prevent an “unbuttoning” of the closure pin 4 from the female part 2 in the case of the corresponding axial loading of the quick connect closure, since the sharp-edged faces 13 cannot leave the undercut between the contoured portion 34 and the head portion 36.

A play-free seating of the quick connect closure is thus established both in the axial and cross-axial directions through the described contact between the closure pin 4 and the female part 2. The axial force (axial bearing pressure) transferable from the quick connect closure is determined by the cross-section of the contoured portion 34 of the closure pin 4, which has the shape of a oval and is similar to a rectangle, as can be seen in FIG. 3.

### Closing the Quick Connect Closure

In order to close the quick connect closure, the closure pin 4 is pushed into the female part 2 in the axial direction (arrow K in FIG. 4). This takes place such that structural member B executes a corresponding axial movement relative to structural component A. The closure pin 4 hereby automatically moves into one of the two locking positions, wherein two closure variants are to be differentiated:

One closure variant is given when the closure pin 4 assumes a rotational position, which corresponds with one of the two locking positions, relative to the female part 2 when inserted into it, as shown in FIG. 4. In this case, the corner areas between the outer surfaces 51 and the guide surfaces 40 of the closure head 36 first rest against the inner surfaces 11 of the spring legs 10 and slide along on them. The spring legs 10 of the female part 2 are hereby warped radially outward until the outer surfaces 51 of the head portion 36 have passed the bottom ends of the spring legs 10. After this, the spring legs 10 spring back inwards due to their reset property so that the quick connect closure assumes the locking position described above. The quick connect closure is then located in its closed state, in which it interconnects the two structural members A and B.

The other closure variant results when the closure pin 4 is guided into a rotation position relative to the female part 2, which deviates from the locking positions. In this case, the closure pin 4 is automatically rotated into one of its two locking positions during the insertion process, namely as follows:

If the head portion 36 of the closure pin 4 comes in contact with the spring legs 10 during the insertion process, the spring legs 10 exert a corresponding spring force on the head portion 36. The closure pin 4 is hereby rotated on axis X such that the inclined surfaces 44 of the head portion 36 come in contact with the inner surfaces 11 of the spring legs 10.

As already mentioned, the lateral edges of the inclined surfaces 44 lying in the radial planes form an angle δ with the axial plane E2 (FIG. 15). The angle δ is larger than the self-locking angle, which results from the coefficient of friction between the materials of the female part 2 and the closure pin 4. For example, in the case of a plastic/plastic material combination, the result is a coefficient of friction of 0.4. The self-locking angle can be calculated from this as follows: INV tg 0.4=22°. The angle δ is thus selected to be larger than 22° in this case, for example on the order of 25°, in order to not prevent a sliding movement between the closure pin 4 and the female part 2 in the area of the inclined surfaces 44.

Once the head portion 36 has passed the bottom end of the spring legs 10, the contoured portion 34 of the closure pin 4 comes in contact with the inner surfaces 11 of the spring legs 10. Stated more exactly, the inner surfaces 11 of the spring legs 10 engage with the rounded corner areas 56 of the contoured portion 34 (see FIGS. 6 and 16). The pre-tensioned spring legs 10 exert a corresponding spring force on the closure pin 4, wherein the closure pin 1 is rotated into one of the two locking positions. It is important to note that the contact between the inner surfaces 11 of the spring legs 10 and the rounded corner areas 56 of the contoured portion 34 takes place at an angle, which is larger than the self-locking angle (the angle δ* in FIG. 6 corresponds with the angle δ in FIG. 14 is rotted by 90° with respect to the angle δ).

The rotation of the closure pin 4 into the locking position, which takes place during the insertion process, thus occurs in two stages: the rotation in the first stage is effected by the interaction of the spring legs 10 with the inclined surfaces 44 of the head portion 36 and the rotation in the second stage is effected by the interaction of the spring legs 10 with the rounded corner areas 56 of the contoured portion 34. Depending on the initial position of the closure pin 4, the rotational movement to the left or right takes place, wherein the rotation at maximum one-quarter of a rotation.

The elongations 22 on the bottom end of the walls 8c, d serve as lateral protection and prevent the closure pin 4 from passing over the walls 8c, d on their bottom ends when the closure pin 4 is turned.

### Opening the Quick Connect Closure

In order to open the quick connect closure, the closure pin 4 is rotated manually or using a tool (not shown) by 90° out of the locking position over the drive portion 24. The push surfaces 42 on the head portion 36 and contoured potion 34 then come in contact with the spring legs 10. The angle of inclination γ, which is formed by the push surfaces 42 with the axial plane E2, is larger than the self-locking angle, which results from the coefficient of friction between the materials of the female part 2 and the closure pin 4 and which can be determined in the same manner as described in connection with the angle δ. Thus, in the exemplary embodiment shown, it is larger than 22° and is for example on the order of 25°. The axial force component of the spring force exerted by the spring legs 10 on the closure pin 4 then ensures that the closure pin 4 is automatically pushed out of the female part 2, wherein the quick connect closure is opened and the connection between the structural members A and B is released.

We claim:

1. A quick connect closure for connecting first and second structural members, said quick connect closure comprising:
a female part adapted to be connected to said first structural member and comprising a pair of opposite spring legs, and
a closure pin adapted to be mounted to said second structural member so as to be rotatable about an axis of said quick connect closure and comprising a drive portion, a shaft-like intermediate portion and a closure body,
said closure pin being adapted to be axially inserted into said female part in order to provide for a locking connection between said closure pin and said female part when said female part and said closure pin are in at least one locking position with respect to each other, and
said spring legs of said female part cooperating with said closure body of said closure pin such that the closure pin is automatically rotated into said at least one locking position when the closure pin is in a rotational position spaced from said at least one locking position at the time when the closure pin is inserted into said female part,
the improvement being that said female part is made of plastic material and is formed as a circumferentially closed box-type body having a pair of wall portions comprising said spring legs which are radially inwardly offset with respect to the remaining box-type body and are resiliently connected thereto.

2. A quick connect closure as defined in claim 1 wherein said spring legs of said female part are connected to the remaining box-type body by a pair of wave-shaped portions which together with said spring legs are of trapezoidal shape in radial planes perpendicular to said axis.

3. A quick connect closure as defined in claim 2 wherein said spring legs and said wave-shaped portions are, in said radial planes, of dimensions which continuously increase in an inserting direction such that said trapezoidal shape of said spring legs and said wave-shaped portions decrease in a direction opposite to said inserting direction.

4. A quick connect closure as defined in claim 3 wherein said spring legs are of a wall thickness which continuously decreases in said insertion direction.

5. A quick connect closure as defined in claim 1 wherein said spring legs terminate in sharp-edged faces which engage said closure pin so as to axially retain it when the quick connect closure is in said at least one locking position.

6. A quick connect closure as defined in claim 1 wherein said female part is adapted to be connected to said first structural member via a snap-lock connection.

7. A quick connect closure as defined in claim 6 wherein said box-type body has a pair of opposite slots each of which is open at one end thereof in order to provide for sufficient flexibility of said female part to enable insertion thereof into a receiving opening of said first structural member.

8. A quick connect closure as defined in claim 6 wherein said snap-lock connection between said female part and said first structural member includes flange portions on opposite sides of said box-type body and projections on the other two sides thereof, said flange portion being axially spaced from said projections by predetermined amounts for engaging said first structural member.

9. A quick connect closure as defined in claim 8 wherein said projections have associated therewith inclined surfaces which are engaged by said first structural member in order to provide for lack of axial play therebetween despite of thickness variations of said first structural member.

10. A quick connect closure as defined in claim 1 wherein said closure body of said closure pin comprises a cylindrical shaft portion, a contact portion, a contoured portion, and a head portion, each of these portions merging into an adjacent portion thereof and a recess being provided between said contoured portion and said head portion for providing said locking connection between said female part and said closure pin.

11. A quick connect closure as defined in claim 10 wherein said cylindrical shaft portion of said closure body is of such a diameter that it is received from a square end portion of said box-type body of said female part without play when the quick connect closure is in said at least one locking position.

12. A quick connect closure as defined in claim 10 wherein said contact portion of said closure body has a pair of planar abutment surfaces which are mirror symmetrical with respect to a first axial plane, said pair of planar abutment surfaces being disposed so as to be central with respect to a second axial plane rotated for 90° with respect to said first axial plane and to be inclined with respect to said first axial plane for such an angle of inclination that said abutment surfaces abut correspondingly inclined planar internal surfaces of said spring legs when said quick connect closure is in said at least one locking position.

13. A quick connect closure as defined in claim 12 wherein a surface of said contact portion outside of said pair of abutment surfaces form an axial extension of said cylindrical shaft portion such that the contact portion has a cross section which changes, in said insertion direction, from a circular cross section to an increasingly flattened oval cross section.

14. A quick connect closure as defined in claim 12 characterized in that said pair of abutment surfaces of the contact portion have angles of inclination less than an angle of inclination about which said internal surfaces of said spring legs of said female part are inclined with respect to said first axial plane when they are in an undeformed condition.

15. A quick connect closure as defined in claim 12 wherein said pair of abutment surfaces of said contact portion extend into said contoured portion and merge into a shoulder rearward of said head portion via a radius for providing a part of said recess of said locking connection between said female part and said closure pin.

16. A quick connect closure as defined in claim 12 wherein said head portion of said closure body of said closure pin is of tapered shape and comprises:
a pair of planar rectangular guide surfaces which are mirror symmetrical with respect to a first axial plane and are inclined with respect thereto for a predetermined first angle,
a pair of planar push surfaces which are mirror symmetrical with respect to a second axial plane offset with respect to the first axial plane for 90° and are inclined with respect thereto for a predetermined second angle, and
four planar inclined surfaces each of which connects a guide surface to a push surface and which are inclined both to said first and second axial planes so as to cooperate with the spring legs of said female part to rotate said closure pin towards said at least one locking position when the closure pin, during its insertion into the female part, is in a rotational position spaced from said at least one locking position.

17. A quick connect closure as defined in claim 16 wherein edges of said inclined surfaces lying in radial planes are inclined with respect to said second axial plane about a third angle which exceeds a self-locking angle defined by a friction coefficient of the materials of said female part and said closure pin.

18. A quick connect closure as defined in claim 16 wherein said contoured portion between said abutment portion and said head portion is of an oval cross section approximating a rectangle and having straight sides and radiused corners which are disposed with respect to said inclined surfaces of said head portion such that they cooperate with said spring legs of said female part to rotate said closure pin into said at least one locking position when the closure pin, during its insertion into said female part, is in a rotational position spaced from said at least one locking position.

19. A quick connect closure as defined in claim 16 wherein said pair of pushing surfaces of said head portion extend via said contoured portion to said contact portion and said second angle exceeds a self-locking angle which is defined by a friction coefficient of the materials of said female part and said closure pin so as to automatically expel said closure pin from said female part when said closure pin is rotated for 90° from said at least one locking position to a release position.
